(19) United States
(12) Patent Application Publication
(10) Pub. No.: US 2008/0292967 A1
(43) Pub. Date: Nov. 27, 2008

(54) Method and Device for Producing a Battery and Battery

(76) Inventors: Ove Nilsson, Kungalv (SE); Britta Haraldsen, Horten (NO)

Correspondence Address: DICKSTEIN SHAPIRO LLP, 1825 EYE STREET NW, Washington, DC, 20006-5403, US

(21) Appl. No.: 12/158,041

(22) PCT Filed: Dec. 13, 2006
(86) PCT No.: PCT/SE2006/001420

§ 371 Date: Jun. 18, 2008

(30) Foreign Application Priority Data
Dec. 21, 2005 (SE) 0502846-9

(51) Int. Cl. H01M 2/16; H01M 6/00; B23P 19/04

(52) U.S. Cl. 429/246; 29/623.5; 29/730

(57) ABSTRACT

A method and a device for manufacturing a battery having a plurality of electrodes, wherein the method includes the step of forming non-formed active material on each electrode. The invention is distinguished in that the electrodes and thereby initially non-formed active material are held under a mechanical pressure during the formation step in order to limit the volume change of the active material during this step. The invention also concerns a battery.

### FIELD OF THE INVENTION

The invention concerns a method and a device for producing a battery according to the preamble of claims 1 and 20, respectively. It also concerns a battery produced accordingly.

### BACKGROUND OF THE INVENTION

The active components of a battery, i.e. the parts storing the chemical energy, are comprised of electrodes in the form of a cathode, often including a metal oxide, for example PbO₂, MnO₂, Ni(OOH) and a an anode, often including a metal, for example Pb, Zn, Cd. In order to use the stored energy, an electrolyte is also needed in contact with the electrodes. This electrolyte is usually a water solution of a salt or an acid.

In lead batteries, the electrolyte includes sulphuric acid. The reactions at the electrode surfaces proceed according to the following diagram for discharge:

At the cathode: PbO₂+4H⁺+SO₄²⁻+2e−=PbSO₄+2H₂O

At the anode: Pb+SO₄²⁻=PbSO₄+2e−

During loading, the above reactions are reversed.

The ions of the sulphuric acid are part of the electrode reactions and form sulphuric sulphate in the electrodes in proportion to the amount of energy taken out there from. It is therefore necessary that the battery comprises sufficient amounts of such ions and that the amount of sulphate corresponds at least to the amount of electrical energy that is calculated to be taken out from the battery. An excess amount of sulphuric acid is usually present so that the electrolyte after a discharge shall consist not only of water.

Sufficient amounts of sulphate ions can be ensured by a certain volume of acid of a certain concentration being added to the battery. The concentration of the sulphuric acid is usually defined as its density and is usually not higher than 1.30 g/cm³ in a charged lead battery. This density corresponds to the concentration 520 g H₂SO₄ per litre electrolyte. Since the rest voltage of a battery cell depends on the density of the acid according to the formula:

v=0.84+density,

there is a desire to increase the acid concentration and possibly reduce the volume of acid in order to reach a better battery performance. This can, however, lead to difficulties during charging since the lead sulphate will be more difficult to dissolve. It is therefore of greatest importance to already during the manufacture control that the right volume of acid with an adequate density is filled into the battery.

A battery can be monopolar or bipolar. In the first-mentioned case, which is the most common, all positive electrodes in the battery are parallel-connected as are all negative. In a bipolar battery there are a number of electrodes that are comprised of an electrically conductive intermediate wall and with the one side provided with a positive active material and the other side with a negative active material. Between each such electrode there is a separator. All electrodes are connected in series. A bipolar battery pile therefore exhibits a high voltage, whereas the monopolar cell exhibits a low voltage. The latter can usually be discharged with a considerably higher current than the bipolar battery.

To understand the invention, the so called formation of a lead battery will now be explained in general.

After the electrodes have been provided with masses of lead being comprised of lead, lead oxides, water and sulphuric acid and, for the negative mass, also some additives such as BaSO₄, soot and so called expander (wood powder or other products from wood), they have to be formed. This means a first charge, wherein the lead components in the positive mass are oxidized electrolytically into PbO₂ (lead dioxide) and the lead components in the negative mass are reduced electrolytically to metallic, porous lead.

This process is best carried out in sulphuric acid of a density of about 1.10 g/cm³, but can also be made with acid of higher density. The low concentration can be used when the electrodes are to be rinsed and dried after formation and thereafter be mounted to batteries, together with separators. A dry-charged battery then will result which can be used as soon as an acid of adequate density has been filled into all cells of the battery. A certain heat development may occur during this filling process.

It is possible to carry out this formation in low acid density directly in the batteries, whereby non-formed electrodes are placed together with separators and are connected to the poles of a battery in a prescribed manner. Thereafter acid of low density is filled into the battery and the formation is started. When the formation is completed, the remaining acid has a density that is somewhat higher than the initial density because of free-setting of the sulphate in the masses. This acid density is, however, not sufficiently high to give the battery sufficient performance, wherefore an exchange of acid has to be undertaken. This is relatively simple in batteries with “flooded electrolyte” but practically impossible in batteries with “starved electrolyte”.

In the latter case a method called “one shot” is used, which means that to the non-formed battery is supplied an acid with such a density and with such a volume that the acid density at the end of the formation is the one that is specified for the performance of the battery.

This formation method has the drawback that the relatively strong acid supplied before formation reacts with the oxides into lead sulphate and water during strong heat development. Thereby is formed PbSO₄ which is difficult to dissolve. There is also a risk that all acid reacts and that the electrolyte will consist almost only of water at the beginning of the formation. This formation method is the only way to date to form AGM batteries (Absorbed Glass Mat), unless these are not manufactured with dry charged electrodes.

During formation, the active materials undergo essential structural transformations which can be uncontrolled and be the reason for undesired properties of the electrodes.

### Aim and Most Important Features of the Invention

It is an aim of the invention to provide a method and a device for the production of batteries, wherein the problems of the background art are avoided.

According to the invention these aims are obtained through a method and a device having the features of claim 1 and 20, respectively.

By applying a mechanical pressure against the active materials they will be formed within a limited or (claim 2) essentially constant volume.

It has proved that through the invention it is possible to control the active materials during formation such that thereby undesired volume changes are limited, whereby undesired surface irregularities of the electrodes are avoided, which could otherwise be problematic with different types of batteries, in particular in batteries having small distances between the electrodes.

Through the invention is avoided that essential structural transformations that the active materials undergo during formation bring about such volume changes that could otherwise result in undesired surface irregularities of the electrodes which could be problematic in different types of batteries. With respect to electrodes for bipolar batteries, through the invention is avoided or at least reduced the risk of volume changes tending to break off the active materials from the generally plane intermediate wall of the electrode.

In particular, a pressure of about 50-250 kPa is applied, and preferably a pressure of about 100-200 kPa, which values have proven to give good results.

By, according to a preferred embodiment, said mechanical pressure is applied by having an even pressure surface of a pressurizing element which contains formation electrolyte under pressure being brought to contact an outer surface of active material on each electrode, access to formation electrolyte is ensured during the control formation.

By, according to another preferred embodiment, the mechanical pressure is applied by means of a hollow pressurizing element, simple supply and access to a desired amount of formation electrolyte.

It is preferred that the pressure is applied by a hollow pressurizing element being comprised of a disc-shaped channelled element, such as a disc of channelled plastic, having perforations on the sides that are turned against the electrodes, since this results in an effective and economic solution.

By, according to a further preferred embodiment, said mechanical pressure is applied by an even pressure surface of a porous pressurizing element, which in its pores contains formation electrolyte, under pressure is brought to contact an outer surface of active material on each electrode, it is achieved that the electrolyte necessary for the formation in an advantageous way is present during the pressurizing. It is suitable that the pressurizing element has a porosity of about 45-90%.

In particular it is preferred that it is an essentially dimension stable, porous pressurizing element.

By, according to an embodiment, formation electrolyte before formation is supplied with such a concentration that the resulting electrolyte concentration after formation corresponds to the concentration of the electrolyte of the completed battery, the method is simplified for the production of the battery.

If the formation is carried out with a plurality of piled electrodes and with intermediate pressurizing elements, wherein the pile is subjected to said mechanical pressure, increased rationality in the method is obtained since a plurality of electrodes can be formed under one and the same pressure simultaneously with a common device within a small volume. The invention is thereby particularly applicable in a bipolar battery, wherein the formation is carried out on a pile of a plurality of bipolar electrodes, for forming on each electrode positive and negative active material on each side of an electrode conducting wall. The invention is particularly preferred with active materials including lead compounds and the electrolyte containing sulphuric acid.

In a preferred aspect of the invention for manufacturing batteries including a number of porous and formed electrodes with electrolyte and, between each pair of electrodes, a separator of inert, possibly fibrous material and electrolyte, enclosed in an electrode room, the electrolyte is supplied to the respective separator before closing the electrode room. Hereby is given the possibility of, in a more controlled manner, ensuring that the battery has been supplied with the correct amount of electrolyte with the right concentration. Filling of acid into a bipolar lead battery is otherwise difficult to undertake such that the acid is distributed evenly in the cell because of the often short distance between a positive electrode and an opposite negative electrode. This distance can be as small as 0.5-1 mm and can be entirely filled with AGM separator.

In particular it is preferred that electrolyte is supplied to the separator before it is brought into contact with both electrodes in its respective electrode pair, possibly after having been put onto one of the electrodes.

The invention makes it possible to assemble formed bipolar electrodes to batteries without rinsing and drying thereof, which otherwise would be complicated since each electrode includes, besides the intermediate wall, the two differently active, formed electrode sides. The invention also makes it possible to avoid the occurrence of high heat development in the battery.

Corresponding advantages are achieved through corresponding device features. Further features and advantages of further claims will be explained below.

### BRIEF DESCRIPTION OF DRAWINGS

FIG. 1 shows in a perspective view a battery according to the invention.

FIG. 2 shows in a sectional view a battery pile of electrodes positioned together against each other and forming sealing surfaces.

FIG. 3A shows partly in section, a battery pile seen from above and including pressurizing elements.

FIG. 3B shows in a perspective view a disassembled pressurizing element according to FIG. 3A.

FIG. 4 shows a cassette for pressurizing a battery pile.

### DESCRIPTION OF EMBODIMENTS

Bipolar batteries are suitable to manufacture in the form of piles of a plurality of electrodes, usually with 48 V nominal voltage, but also up to 200 V exists.

This means that 24 or up to 96 electrodes are connected in series. Batteries manufactured according to the invention can be brought to have such high grade of accuracy that high precision demands can be fulfilled because the electrodes are formed in a controlled manner.

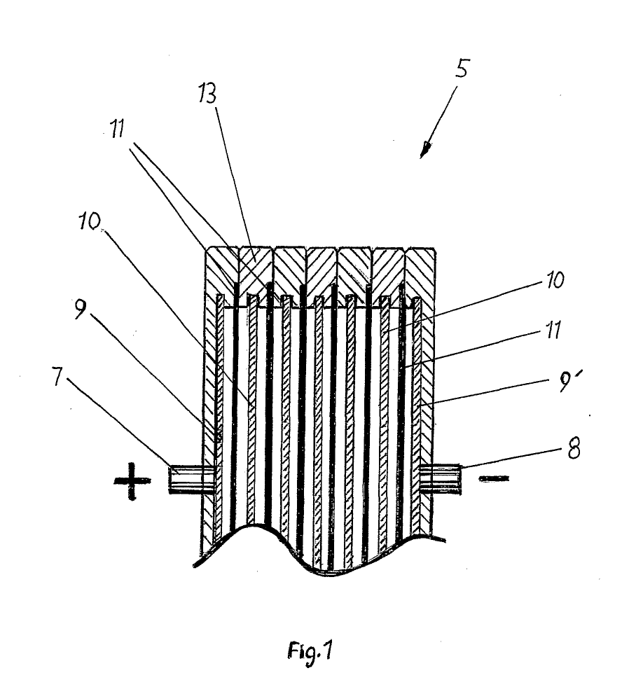

With reference to FIG. 1 is shown the principle of a bipolar battery which includes a plurality of bipolar electrodes, which are not connected to each other by external connections but are assembled in a pile 5 by piling of first an end electrode 9 having a current collector 7, thereafter a separator 11, a bipolar electrode 10, a separator 11 and so on, and be terminated with a new end electrode 9′ with a current collector 8 but of opposite polarity. Each electrode is constructed with a frame 13 such that its side when they are laid together to a pile, will enclose all necessary electrolyte between the positive side of the one bipolar electrode and the negative side of the adjacent electrode.

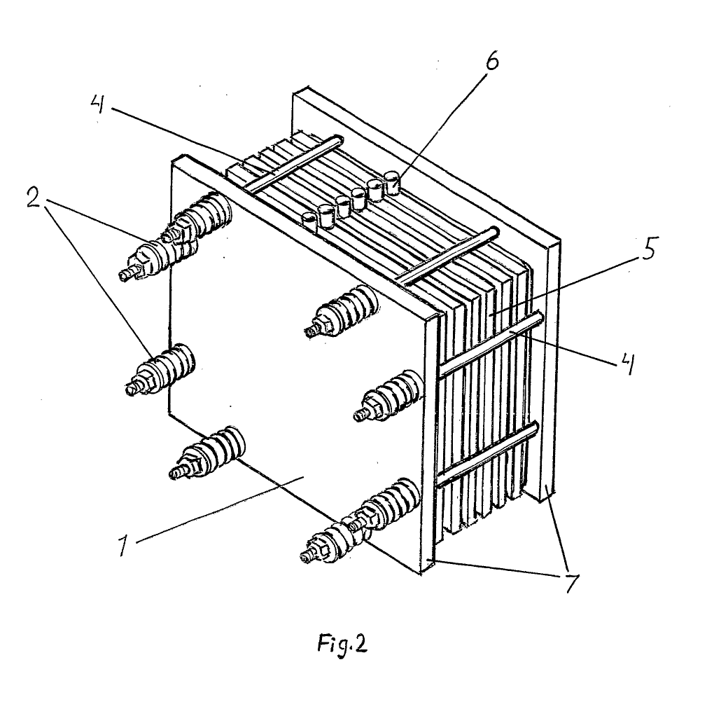

In FIG. 2 is shown a battery 1 including a pile 5, held together between pressure plates 7 by tension rods 4. Nut-loaded springs 2 are used here in order to obtain an increased desired pressure on the pile.

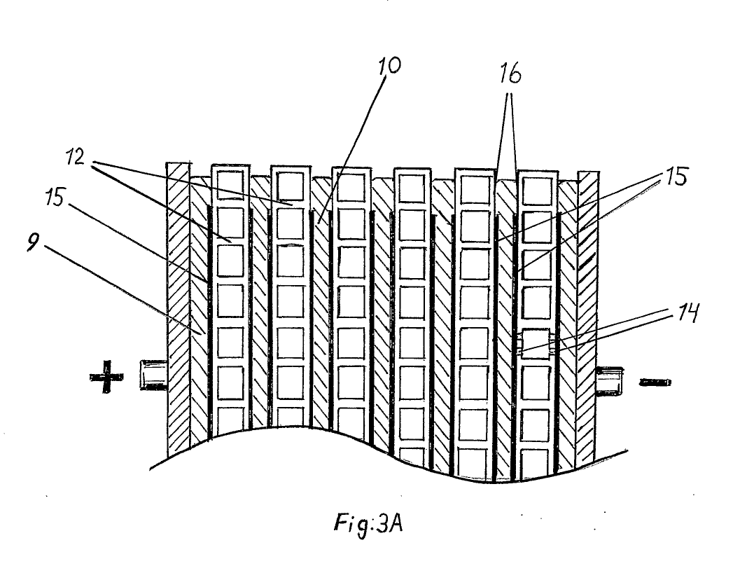

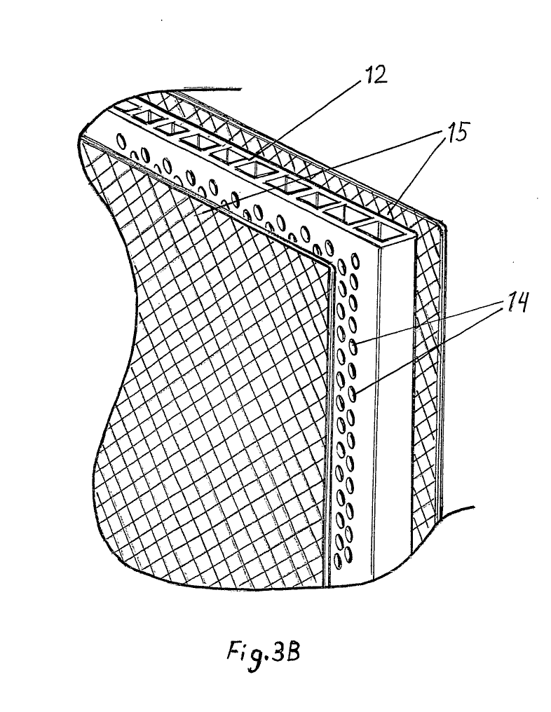

In one embodiment of the invention, as is apparent from FIG. 3A, the bipolar electrodes 10 will, before formation, be piled in a corresponding manner. The pressurizing elements 12 which are provided for the formation step are suitably constructed in another way than the separators of the completed assembled batteries. When the formation only concerns a first charge and possibly a few discharges, so called processing, these pressurizing elements 12 do not need to be as flexible (elastic) or as porous as the separators in the battery. They should be relatively pressure-stable and shall be acid resistant. Formation with the same sealed enclosure as exists in the manufactured battery is not possible because of the fact that the separator in such a case is only about 0.5-1.0 mm. Sufficient acid volume is then not possible to add without resulting in too high temperature and strong sulphate formation. In the embodiment in FIG. 3A, however, the pressurizing elements 12 are designed with an inner volume for receiving a sufficient amount of electrolyte. As an example, channel elements including two thin sheets which are separated and connected over a number of parallel intermediate walls come into use. Channel plastic of a relatively rigid plastic material, such as for example polycarbonate, can advantageously be use when producing the pressurizing elements 12.

Since the formation is best carried out with electrolyte of low density, these pressurizing elements 12 shall have a thickness which preferably is considerably greater than the separators that are used in the completed assembled batteries. By choosing a great volume of electrolyte, which will follow from the greater thickness of the pressurizing elements 12, the concentration is not affected to an extent worth mentioning through the free-setting of the sulphate amount bound in the electrode masses.

It can, however, be a reason for carrying out the formation in higher acid concentration even so high that the concentration after the formation has reached the same value as is intended in an assembled battery, so called “one-shot” formation. Thereby the advantage is obtained that smaller volumes of electrolyte need to be re-circulated. In such a case, the concentration and volume of the electrolyte at the beginning of the formation is adapted to the contents of sulphate in the active, non-formed masses.

The pressurizing element 12 is in contact against the entire positive electrode surface and the entire negative electrode surface, and is in one embodiment constructed such that sealing surfaces directly or indirectly are pressed against the frames 13 which hold the electrodes 10 in order to create enclosures for electrolyte. This can be seen on FIG. 3A at 16. Further, the pressurizing elements are over the sides that are turned against the electrodes provided with a number of holes 14, which ensure that the electrolyte easily can reach the electrodes. Edge-portions of the pressurizing element 12 in FIG. 3B has a region without holes which serves as a sealing surface.

The outside surfaces of the pressurizing elements are designed such that the active material is not damaged when the pile is pressed together. As an example, and as illustrated in FIGS. 3A and B, an equalizing layer in the form of a thin yielding layer such as a fibreglass mat 15 of the AGM type is positioned on each pressurizing side of the pressurizing element in order to constitute the pressure transferring surface, which gives a gentle pressure transfer effect and also electrolyte distributing effect. This can with advantage be applied also on porous pressurizing elements (see below).

The applied pressure can be between 50 and 250 kPa, preferably between 100 and 200 kPa.

The thickness of the pressurizing elements is normally chosen between 5 and 25 mm, preferably between 10 and 20 mm, with the lower value for the so called “one-shot” formation.

The pressurizing elements can also be porous having a material porosity between 45 and 90%. This is limited only by the mechanical strength of the material. The pore structure in the material in the pressurizing element shall be even having pore openings sufficiently big for allowing a quick exchange of formation electrolyte to an electrolyte of another concentration.

The electrodes can be positioned inside cassettes or holders already after pasting, i.e. when the positive and negative masses, respectively, are applied on the bipolar intermediate wall. According to one aspect of the invention bipolar electrodes are formed which are applied with both positive and negative masses which results in that these electrodes in an advantageous manner thereby will be subjected to a maturity process together. Further, according to the invention, the active materials shall be under a certain pressure during formation. The still moist electrodes are put under a certain pressure in a cassette whereupon this pressure in general is maintained also during the formation.

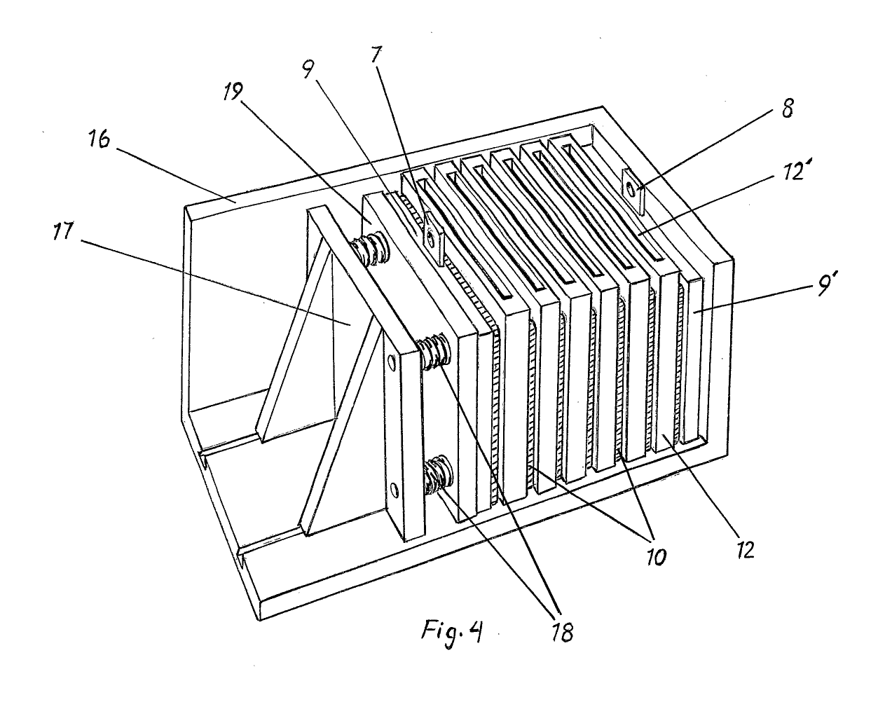

FIG. 4 shows a cassette 16, which includes a space for receiving a pile of electrodes 9, 10, . . . , 9′ and intermediate pressurizing elements 12. Sideward current collectors are indicated with 7 and 8. A support plate 17 is secured in grooves in a wall of the cassette such that a number of springs 18 apply a desired force against a pressure plate 19, which in turn applies the desired pressure against the pile. The acid for the formation is added after assembly into the cassette through openings 12′ in the pressurizing elements.

It is, however, also possible to first let the electrodes go through the maturity process (that is oxidizing Pb, forming lead sulphate crystals and binding the masses) and drying in order to achieve the same properties as are described above and thereupon mount the dry electrodes with the pressurizing elements. Hereby the applied masses can be protected during maturity with for example plastic films in order not to stick onto each other.

Considering that the subsequent formation thereafter is to be carried out in the same equipment (cassette or holder) and at the same pressure, it must be constructed such that no current leakage can exist. All current shall during formation pass from the positive side of one electrode to the closest lying negative side of the opposite electrode.

The device for maturing and formation should suitably include one or several possibilities of ventilation. The ventilation can be closed during the first part of maturing in order to later be opened during the drying step. This can simply and automatically be arranged for example in an electric way. It is also possible that this ventilation is designed such that it can act as gas discharger during formation since, in any case at the end of the formation step, hydrogen gas as well as oxygen gas are developed.

After the formation step, the battery is to be finally assembled. The electrodes in the device are unfastened one after the other, the pressurizing elements are washed and dried possibly for re-use and the electrodes are piled in the same way as earlier before the formation. They are, however, wet from acid and—particularly the negative ones—need to be protected from oxidation by the oxygen in the air or at least put together in said pile within one or a few minutes.

According to a preferred aspect of the present invention, the separators inserted into the battery will contain a predetermined amount of acid, whereby it is suitable that this amount corresponds to about 80-100% of the pore volume of the separator in an operational battery, possibly with a pressure loaded battery pile. In a preferred construction, the amount of electrolyte corresponds to about 85-95% of said pore volume.

Since the separators will be pressed together under the weight of the electrodes in the pile, or, which is preferred, in that after assembly, the pile has been subjected to an outer pressure of a determined magnitude, a part of the added acid will be pressed out from the separators. The separators in the battery will in that case be entirely filled with acid and oxygen gas recombination will not start in these cells until a part of this acid volume has been consumed by gas discharge.

In a preferred embodiment is added to each separator a volume of acid which is adapted such that nothing of this amount of acid is pressed out from the separator at the pressure which is applied over the pile. Handling acid-wet separators has shown to be relatively free from problems with small or no acid leakage when moved.

One of the advantages with this part of the invention is that the separators can be assembled in the battery together with acid filled electrodes. These can thus be brought over from the formation process directly to the assembling of the battery without rinsing and drying, which is work saving, environmental-friendly and economic. The acid that is added to the separators should in a preferred case have the same density (concentration) as that which is present in the pore system of the electrodes, but can be higher or lower depending on how the formation process has been carried out.

Oxygen gas recombination means that during charge, oxygen gas is formed on the positive electrode when voltage-temperature-current is sufficiently high. In order as mush as possible to prevent harmful effects from this side-reaction, the batteries are provided with valves 6 in FIG. 2 of a simple kind that shall prevent too high pressure inside the cell, but above all to give the formed oxygen gas time to diffuse over to the negative electrode where it is reduced back into water.

If this reduction of the oxygen gas cannot be achieved, the working life of the battery will be shortened because of loss of water to the surroundings. A condition for carrying out this reaction in a bipolar pile battery having separators, is that the separator is not completely filled with sulphuric acid but allows oxygen gas transport. AGM separators usually have a porosity of about 96% but should, in order for the oxygen gas recombination to work, have only about 90% of its pores filled. By supplying the electrolyte to the separators before closing the electrode room, it is thus achieved the possibilities of supplying certain amounts of electrolyte in a secure manner. Further manufacturing technical advantages are achieved with respect to reduction of the number of steps to be taken when assembling the battery. Each bipolar electrode can thus with great security simply be given the same volume of acid and acid of the same density, which is particularly important when batteries with high battery voltages are manufactured.

The batteries wherein the invention is firstly intended to be applied have separators of AGM type, i.e. high-porous and compressible. The invention can, however, also be applied on non-compressible separators.

AGM separators that mainly consist of micro-fine glass wool can be reinforced in different ways, for example with elements of organic fibres, be impregnated with silica gel (WO 2004/021478 A1) but all have the properties that they can contain great amounts of electrolyte in relation to its own volume.

In a preferred method of assembling a bipolar battery, the acid-wet electrodes are positioned horizontally. Thereafter the separator having the correct amount of acid is positioned on the uppermost electrode, whereupon the next electrode, monopolar or bipolar, is placed on the separator. The next separator is positioned above this electrode etc. into a pile. A monopolar pile usually starts and ends with a negative electrode and has positive and negative electrodes connected in parallel. The electrode package is then pressed together, possibly with a predetermined pressure, or into a certain thickness, and is put into the battery vessel.

As an example of an automatic production, the separators can be shaped or cut to the correct dimensions and be transferred to a disc which is separable in the centre and is brought forwardly to an electrode pile. The uppermost electrode is suitably always held at a constant height through per se known methods. The separator is now supplied with a certain amount of acid of a certain density through for example nozzles that spread the acid as a spray or with larger drops evenly over the surface of the separator.

In general, other ways of supplying electrolyte can come into question, such as dipping the separator into a certain amount of electrolyte or supply electrolyte with a continuous jet.

When the disc reaches the right position above the uppermost electrode in the pile, the disc is separated and the filled separator falls into position. A new electrode is put on the pile and the height of the pile is adjusted whereupon a new separator is supplied with acid, put forward into position, etc.

As an alternative method, the electrolyte can be supplied to the separator in a corresponding way as is described above after having been positioned above an electrode and before the next electrode has been positioned.

For certain reasons which are well-known to a person skilled in the art, the battery electrolyte is often supplemented with small amounts of additives. As concerns the electrolyte of the lead battery, sulphuric acid, for example inorganic salts can be added, Na₂SO₄, H₃PO₄ or other chemical compounds. In case these additives are not already included in the formation acid, they can be included in the acid that is filled into the separator. The concentration of the additives in question should then be somewhat higher than what is prescribed, in order for the battery to have the right concentration of these additives.

Since the bipolar electrode has one side with positive material and one side with negative material, such an electrode cannot be dry-charged without difficulties, i.e. first formed and then dried, since the two sides require different drying methods.

It is of course possible to envisage that the electrode halves each are processed separately into formed, dried state and then united through for example soldering. The invention can be applied also to such electrodes.

The invention is mainly applicable for lead batteries having bipolar electrodes but is, however, not limited to such batteries but can be applied to other types of lead batteries or even batteries of other kinds which include one or more formation steps.

1. Method for manufacturing a battery having a plurality of electrodes, wherein the method includes the step of formation of non-formed active material on each electrode, and wherein the electrode and thereby initially non-formed active material are held under a mechanical pressure during formation in order to limit the volume change of the active material during this step, characterized in:
that the formation step is performed on bipolar electrodes having one side with positive active material and one side with negative active material, and
that the electrodes after the formation step are unfastened and subsequently assembled to complete a battery with separators between the electrodes.

2. Method according to claim 1, characterized in that the mechanical pressure is applied such that active material is formed within an essentially constant volume.

3. Method according to claim 1, characterized in that a mechanical pressure of about 50-250 kPa and particularly preferred about 100-200 kPa is applied.

4. Method according to claim 1, characterized in that said mechanical pressure is applied by an even pressure surface of a pressurizing element, which contains formation electrolyte, under pressure being brought into contact against an outer surface of active material on each electrode.

5. Method according to claim 1, characterized in that the mechanical pressure is applied by means of a hollow pressurizing element.

6. Method according to claim 5, characterized in that the pressure is applied through a hollow pressurizing element being comprised of a disc shaped channel element such as a disc of channel plastic having perforations on its sides that are turned against the electrodes.

7. Method according to claim 1, characterized in that the mechanical pressure is applied by-means of a porous pressurizing element, which in its pores contains formation electrolyte.

8. Method according to claim 7, characterized in that the mechanical pressure is applied by means of a pressurizing element having a porosity of about 45-90%.

9. Method according to claim 1, characterized in that formation electrolyte is supplied prior to formation having such a concentration that after formation a resulting electrolyte concentration corresponds to the concentration of the electrolyte of the completed battery.

10. Method according to claim 1, characterized in that the formation is effected with a plurality of electrodes put in a pile with intermediate pressurizing elements, wherein the pile is subjected to said mechanical pressure.

11. Method according to claim 1, wherein the battery is a bipolar battery, characterized in that the formation is carried out on a pile of a number of bipolar electrodes, for forming on each electrode positive and negative active material on either side of an electron conductive wall.

12. Method according to claim 11, characterized in that also a positive and a negative end electrode are formed.

13. Method according to claim 11, characterized in that the active materials include compounds of lead and that the electrolyte includes sulphuric acid.

14. Method according to claim 1, for manufacturing of batteries including a plurality of porous and formed electrodes with electrolyte and, between each pair of electrodes, a separator of inert fibrous material and electrolyte enclosed in an electrode room, characterized in that the electrolyte is supplied to the respective separator before it is brought into contact with its respective electrode pair and the electrode room is closed.

15. Method according to claim 14, characterized in that a separator is shaped, supplied with a predetermined amount of acid, is brought forward to a pile of formed electrodes and is positioned on the uppermost electrode in the pile, whereupon a further electrode is positioned on the separator and the above steps are repeated a desired number of times until a battery having the desired performance is obtained.

16. Method according to claim 14, characterized in that the electrolyte is supplied to AGM separators.

17. Method according to claim 14, characterized in that a pile of a plurality of electrodes and intermediate separators is pressurized to between about 50-250 kPa and most preferred between about 100-200 kPa.

18. Method according to claim 14, characterized in that the electrolyte is supplied after that the separator has been positioned on one of the electrodes in said electrode pair whereupon the second electrode in the electrode pair is positioned on the separator.

19. Method according to claim 14, characterized in that the separators are supplied with electrolyte in the form the same acid that is present in the electrodes with a density which is adapted for the final acid density of the operational battery.

20. Method according to claim 19, characterized in that the separators are supplied with electrolyte containing additives of inorganic salts.

21. Method according to claim 14, characterized in that electrolyte is supplied to the separators in such an amount that the pore volume of the separators is filled to between about 80 and 100% calculated for the operational condition of the battery.

22. Method according to claim 14, characterized in that the electrolyte is supplied to the separators in such an amount that the pore volumes of the separators are filled to between about 85 and 95% calculated for the operational condition of the battery.

23. Device for the manufacture of a battery with a plurality of electrodes each having formed active material, wherein the device exhibits means for holding initially non-formed active material under a mechanical pressure during formation, in order to limit the volume changes of the active materials during this step, and a holder for receiving non-formed electrodes, characterized in
that the device is adapted to perform the formation step on bipolar electrodes having positive active material on one side and negative active material on one side, and
that the device is arranged such that the electrodes after the formation step are unfastened, so that they can be subsequently assembled to complete a battery with separators between the electrodes.

24. Device according to claim 23, characterized in that said means are adapted to apply the mechanical pressure such that active material is formed within an essentially constant volume

25. Device according to claim 23, characterized in that said means includes a pressurizing element, which is arranged so as to contain formation electrolyte, with an even pressurizing surface for applying mechanical pressure against an outer surface of active material on each electrode.

26. Device according to claim 25, characterized in that the pressurizing element is essentially dimensional stable.

27. Device according to claim 25, characterized in that the pressurizing element is hollow.

28. Device according to claim 27, characterized in that the pressurizing element has perforations in its sides which are intended for contacting electrodes.

29. Device according to claim 25, characterized in that the pressurizing element is porous having a porosity of about 45-90%.

30. Device according to claim 23, characterized in that the pressurizing element is provided with a levelling layer on its pressurizing surfaces.

31. Device according to claim 23, characterized in means for performing the formation with a plurality of electrodes put in a pile with intermediate pressurizing elements, and means for subjecting the pile to said mechanical pressure.

32. Device according to claim 23, characterized in means for shaping a separator, supplying it with a predetermined amount of acid, moving it horizontally to a pile of formed electrodes and positioning it on the uppermost electrode in the pile and for repeating this step.

33. Battery including electrolyte, bipolar electrodes with positive and negative active material, and separators between the electrodes, said electrodes in assembly exhibiting limited volume changes in the active material as a result of having been held under a mechanical pressure which limits volume changes inside a holder during a formation step, wherein the electrodes, after the formation step, have been unfastened and subsequently assembled to complete the battery.
